(19) United States
(12) Patent Application Publication
(10) Pub. No.: US 2006/0070546 A1
(43) Pub. Date: Apr. 6, 2006

(54) Method and apparatus for printing an image onto a 3-dimensional surface

(76) Inventors: George Fenwick Smith, Consett (GB); Brendan Joseph Campbell, Tyne & Wear (GB)

Correspondence Address: Jack Schwartz & Associates, Suite 1510, 1350 Broadway, New York, NY, 10018, US

(21) Appl. No.: 10/526,300

(22) PCT Filed: Sep. 4, 2003
(86) PCT No.: PCT/GB03/03825

§ 371 Date: Aug. 31, 2005

(30) Foreign Application Priority Data
Sep. 7, 2002 (GB) 0220864.3

(51) Int. Cl. B41L 35/14

(52) U.S. Cl. 101/488

(57) ABSTRACT

A printing apparatus (1) for printing an image onto a 3-dimensional surface of a plastics article such as a mobile telephone or computer mouse (not shown) has a housing (2) having a slot (3) for receiving a drawer (4) for receiving one of more of the articles to be printed. The drawer (4) is provided with clamp release buttons (5) on a front surface (6) thereof. The housing (2) contains a heater box (7), located above the slot (3), and having a fan (8) for directing hot air through a separator plate (9) onto a transfer element (not shown) mounted on the top of drawer (4) over the article on which an image is to be printed. The transfer element has a support layer of met,allised amorphous polyethylene terephthalate (APET) having an aqueous coating of polyvinyl polymers, which may also contain synthetic silica, surfactants and optical brightening agents. The metallisation is formed by applying one or more metallic coatings to one side of the APET film during manufacture. The heater box (7) is provided with a heater (not shown) which is controlled by means of an electrical enclosure (10) containing a programmable logic controller (PLC) and heating controller.

The present invention relates to a method and apparatus for printing an image onto a 3-dimensional surface, and relates particularly, but not exclusively, to a method and apparatus for printing an image onto an article of plastics material having a protective coating thereon.

A method of printing an image onto a 3-dimensional surface of a plastics article such as a mobile telephone is disclosed in our international patent application WO 01/96123. In this method, a transfer element carrying an image is heated to make it more flexible, and the heated transfer element is applied by means of vacuum forming to the 3-dimensional surface with substantially uniform pressure across the area of contact. The transfer element is then heated to at least partially transfer the image from the transfer element to the 3-dimensional surface.

Plastics articles onto which images have been printed are often provided with protective gloss coatings to avoid scratching or other degradation of the image. Such gloss coatings are generally applied to the article, subsequently to the image printing process, by means of chemical spraying of the gloss coating. As a result of the often hazardous nature of chemicals used in the formation of the gloss coating, the known printing process suffers from the drawback that the gloss coating must be applied by skilled personnel using specialist facilities. This in turn causes the drawback that although the image printing process can be carried out by persons relatively unskilled in printing, the printed article must be returned subsequently to printing to specialist premises for application of the gloss coating. This significantly increases the cost of production of printed articles using the known process.

Preferred embodiments of the present invention seek to overcome the above disadvantages of the prior art.

According to an aspect of the present invention, there is provided a method of printing an image onto a 3-dimensional surface, the method comprising:

heating a transfer element having an image printed thereon to make the transfer element more flexible;

applying the heated transfer element to a 3-dimensional surface having a protective coating thereon, with substantially uniform pressure across the area of contact between the transfer element and the surface, such that the image faces the surface; and

heating the transfer element to at least partially transfer the image into the protective coating.

By at least partially transferring the image into or through the protective coating, this provides the advantage that the protective coating can be applied prior to the printing step. As a result, the printing step can be carried out by persons who are relatively unskilled in printing, subsequently to application of the protective coating at a location having specialist equipment, without the need to subsequently transport printed articles to the specialist location for application of the protective coating. This in turn provides the advantage of reducing the cost of production of printed articles using the method, as well as significantly increasing the range of applications of the method.

The method may further comprise the step of applying said protective coating.

The method may further comprise the step of applying a receptor coating prior to application of said protective coating.

This provides the advantage of enabling better adhesion of an image to the surface to be printed, and the receptor coating can be applied at the same specialist location used to apply the protective coating, and by means of similar, or the same, apparatus as that used to apply the protective coating.

The method may further comprise the step of printing an image onto said transfer element.

The image may be printed by means of a digital printer.

This provides the advantage of enabling customised images to be printed onto the surface, for example by means of data on a user's computer sent to the digital printer.

The transfer element may be applied to the surface by means of vacuum forming.

This provides the advantage of enabling the transfer element to be easily applied to the surface with substantially uniform pressure across the area of contact between the transfer element and the surface.

The transfer element may be at least partially heated by means of hot gas.

This provides the advantage of enabling more uniform and efficient heating than in the prior art, and avoiding shadows which would otherwise occur if a source of radiant heat were to be used.

The method may further comprise the step of applying a thermally conductive film to the transfer element.

This provides the advantage of improving the heat resistance and thermal forming properties of the transfer element.

The method may further comprise a step of removing solvent and/or moisture from a region adjacent said transfer element during heating thereof.

This provides the advantage of minimising the occurrence of bubbles between the protective coating and the transfer element.

According to another aspect of the invention, there is provided an apparatus for printing an image onto a 3-dimensional surface, the apparatus comprising:

fixing means for fixing a transfer element, having an image printed thereon, in position relative to a 3-dimensional surface on which an image is to be printed and having a protective coating applied thereto;

heating means for heating the transfer element to make it more flexible and to at least partially transfer the image into the protective coating; and

application means for applying the flexible transfer element to the surface with substantially uniform pressure across the area of contact between the transfer element and the surface such that the image faces the surface.

By providing fixing means for fixing the transfer element in position relative to the surface, this provides the advantage of enabling the image to be reliably and accurately located on the surface. This in turn enables the printing operation to be carried out by persons relatively unskilled in printing, which in turn increases the range of applications of the printing process.

The fixing means may comprise at least one recess for receiving at least one part having a respective 3-dimensional surface, and for fixing a respective transfer element relative to the or each said part.

The recess may be at least partially removable from a housing of the apparatus, and the fixing means may be adapted to fix the transfer element in response to insertion of the recess into the housing.

This provides the advantage of making the apparatus easier to use, as a result of which images can be printed onto 3-dimensional surfaces by means of non-specialist personnel.

The apparatus may comprise further fixing means for holding the or each said recess in position in the housing.

The apparatus may further comprise control means for actuating the heating means and/or the application means in response to insertion of the recess into the housing.

The heating means may be adapted to direct hot gas towards the surface.

This provides the advantage of enabling more efficient and uniform heating of the surface than in the case of the prior art.

The apparatus may further comprise moisture and/or solvent removing means for removing solvent and/or moisture from a region adjacent the transfer element.

This provides the advantage of minimising the occurrence of bubbles between the protective coating and the transfer element.

The application means may comprise vacuum forming means.

This provides the advantage of enabling the transfer element to be conveniently applied to the surface with substantially uniform pressure across the area of contact.

According to a further aspect of the present invention, there is provided a transfer element adapted to have an image printed thereon, the transfer element comprising:

a carrier layer adapted to be heated to make the carrier layer more flexible;

an image supporting layer; and

a thermally conducting layer.

By providing a thermally conducting layer, this provides the advantage of improving the heat resistance and thermal forming properties of the transfer element.

A preferred embodiment of the present invention will now be described, by way of example only and not in any limitative sense, with reference to the accompanying drawings, in which:—

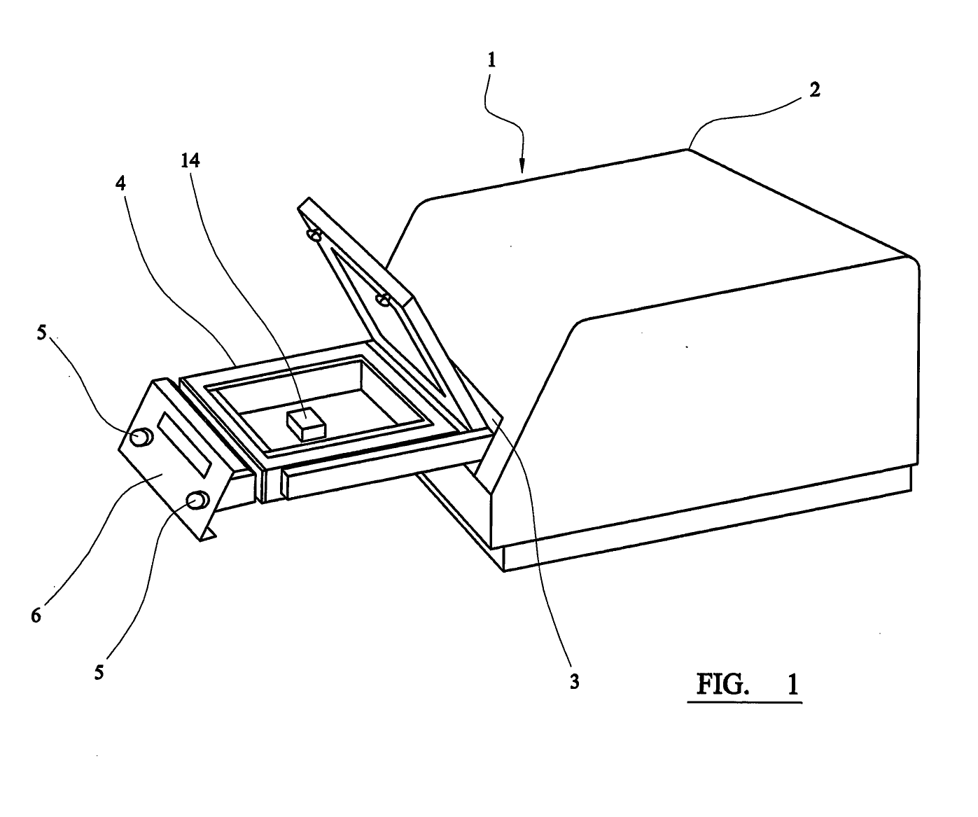

FIG. 1 is a perspective view of a printing apparatus embodying the present invention and with a product receiving drawer thereof in an open condition;

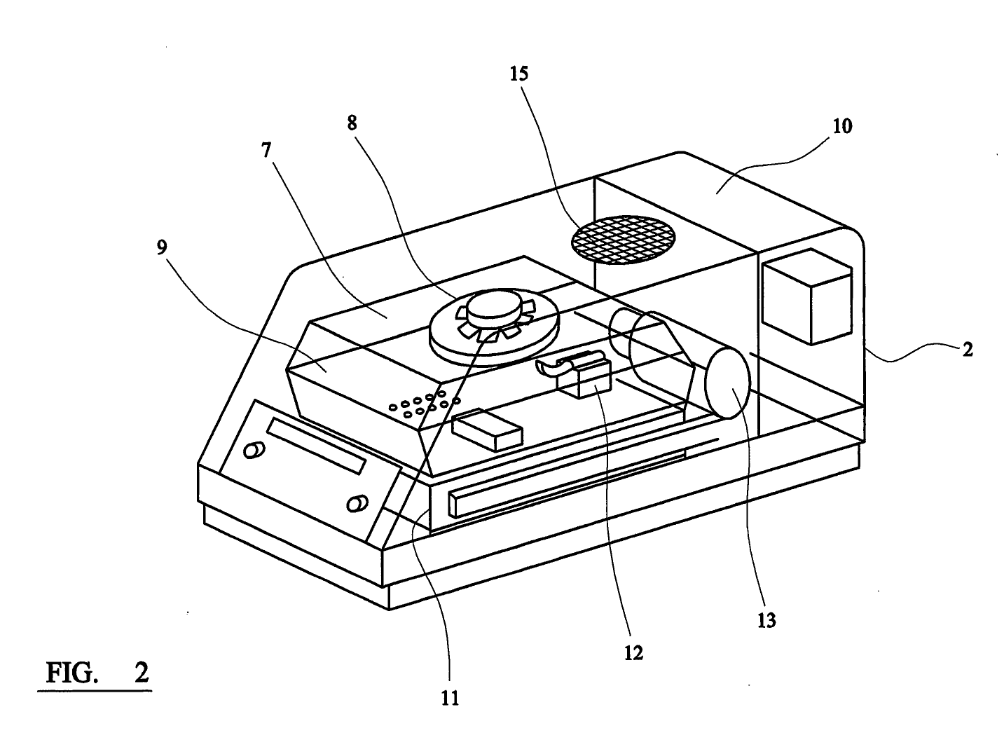

FIG. 2 is a schematic perspective view of the apparatus of FIG. 1 with the product receiving drawer thereof in a closed condition and showing internal components of the apparatus;

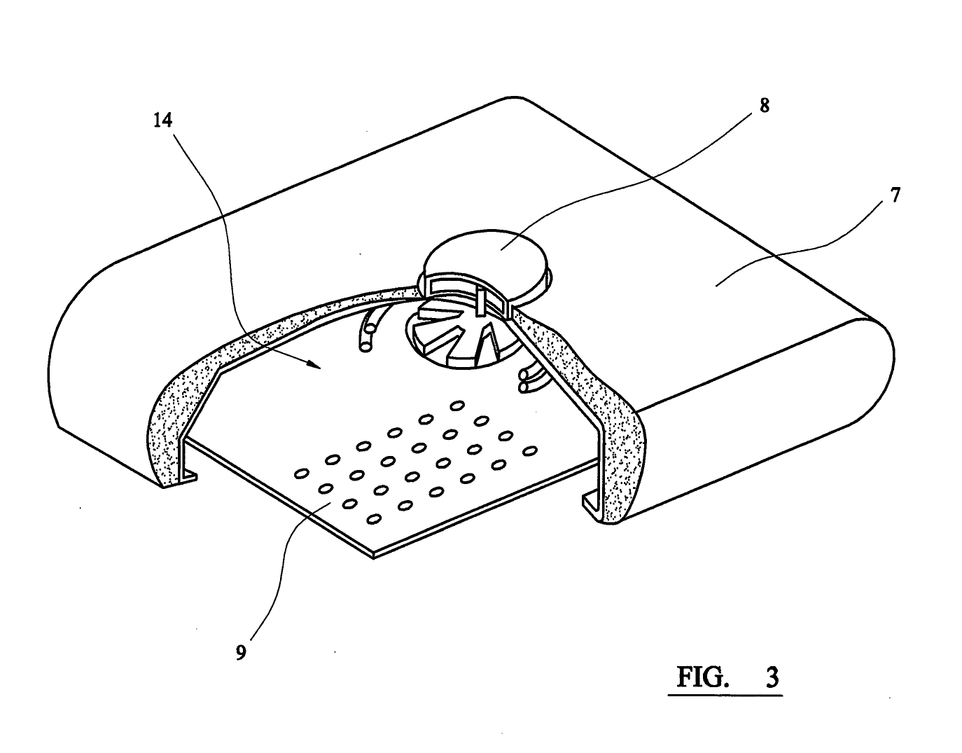

FIG. 3 is a partially cut away perspective view of a circulating fan and separator plate of the apparatus of FIGS. 1 and 2;

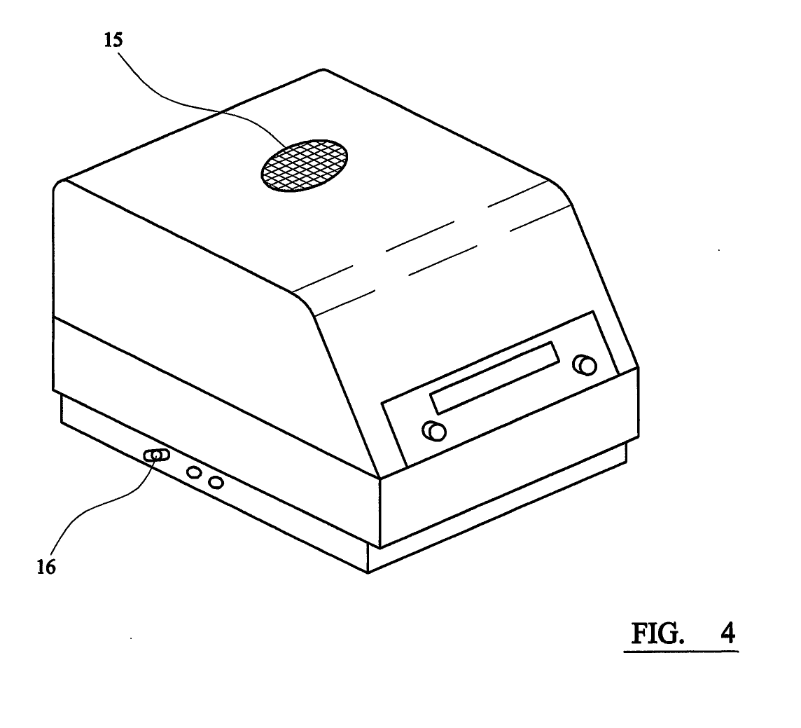

FIG. 4 is a perspective view of the apparatus of FIG. 1 with the product receiving drawer in a closed condition; and

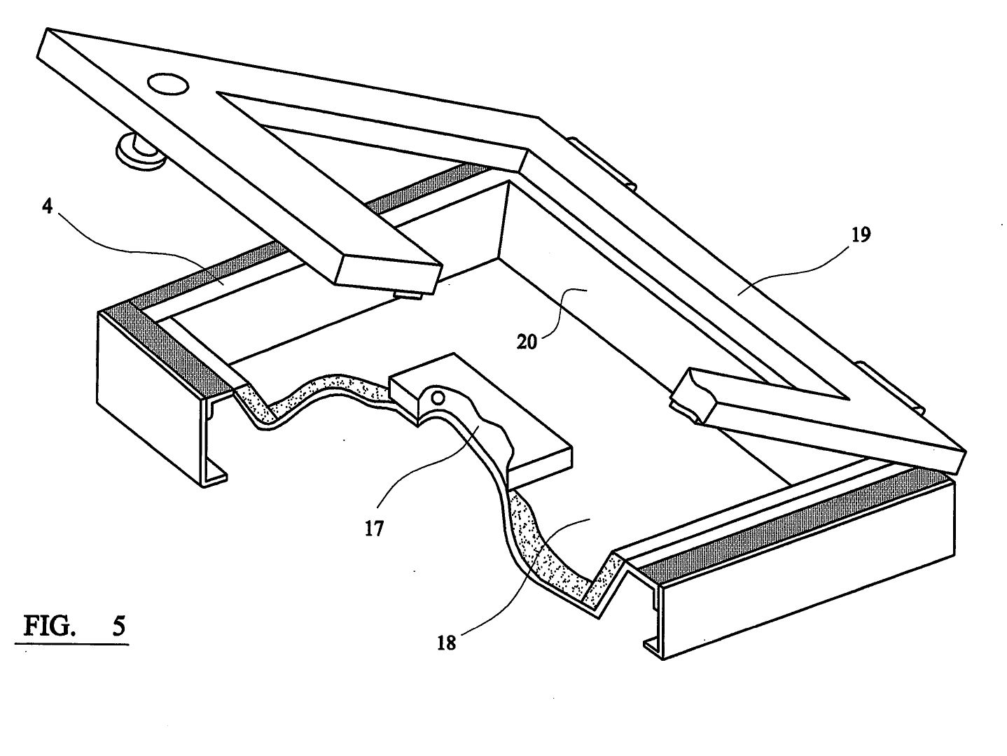

FIG. 5 is a detailed, partially cut away view of the product receiving drawer of the apparatus of FIG. 1.

Referring to FIGS. 1 and 2, a printing apparatus 1 for printing an image onto a 3-dimensional surface of a plastics article such as a mobile telephone or computer mouse (not shown) has a housing 2 having a slot 3 for receiving a drawer 4 for receiving one of more of the articles to be printed. The drawer 4 is provided with clamp release buttons 5 on a front surface 6 thereof, the function of which will be described in greater detail below.

As shown more clearly in FIG. 2, the housing 2 contains a heater box 7, located above the slot 3, and having a fan 8 for directing hot air through a separator plate 9 onto a transfer element (not shown) mounted on the top of drawer 4 over the article on which an image is to be printed. The transfer element has a support layer of metallised amorphous polyethylene terephthalate (APET) having an aqueous coating of polyvinyl polymers, which may also contain synthetic silica, surfactants and optical brightening agents. The metallisation is formed by applying one or more metallic coatings to one side of the APET film during manufacture. The heater box 7 is provided with a heater (not shown) which is controlled by means of an electrical enclosure 10 containing a programmable logic controller (PLC) and heating controller.

The drawer 4 is slidably mounted in the slot 3 by means of slides 11 and is held in position in the slot 3 during the printing operation by means of a solenoid 12. A vacuum pump 13 is also provided in the housing for vacuum forming the transfer element onto the article to be printed and for removing moisture and/or solvent from the air around the transfer element, the purpose of which will be described in greater detail below.

Referring to FIG. 3, the heater box 7 defines a heater chamber 14 which directs hot air through separator plate 9 towards the drawer 4. The drawer 4 defines a vacuum chamber below the heater chamber 14, the temperature of the vacuum chamber being maintained generally constant by means of a fan 15 (FIG. 2) located outside of the heater chamber 14. The solenoid 12 is controlled by means of a drawer release catch 16 (FIG. 4).

Referring to FIG. 5, the drawer 4 has a component mould mount block 17 for receiving a mould (not shown) on which an article of plastics material having a 3-dimensional surface to be printed with an image is mounted. The mould mount block 17 is located at the bottom of a recess 18 for receiving the plastics article, and a film clamp frame 19 is hinged to the rear side 20 of drawer 4 to enable a suitably shaped transfer element printed with an image (not shown) to be immovably clamped to the top of the drawer 4.

The operation of the apparatus shown in FIGS. 1 to 5 will now be described.

In order to print an image onto a 3-dimensional surface of a plastics article, the article is first provided with an optional receptor coating, and is then provided with a gloss protective coating, by means of chemical spraying at a specialist spraying facility remote from the location of the apparatus 1. The transfer element (not shown) comprises a film of plastics material having a metallised coating and having an image printed thereon by means of a conventional digital printer. The image can be printed onto the transfer element by the same person as operates the apparatus 1 for printing the image onto the 3-dimensional surface of the plastics article.

The plastics article is located in recess 18 in drawer 4, and the transfer element rigidly clamped to the top of drawer 4 by means of clamp frame 19 such that the coating printed with the image faces towards the plastics article. The drawer 4 is then pushed into the slot 3 and the apparatus actuated. Hot air is initially directed towards the transfer element to heat it and make it more flexible, and the transfer element is then vacuum formed by means of vacuum pump 13 onto the 3-dimensional surface. Further heat is then directed by means of fan 8 onto the transfer element, which causes the image to be at least partially transferred into or through the protective coating on the plastics article. The vacuum pump 13 also removes moisture and/or solvent from the air around the article to minimise the formation of bubbles between the protective coating and the transfer element.

When the printing process is completed, the manual drawer release 16 is depressed to allow the drawer 4 to be removed from the slot 3 and the printed product to cool. The deformed transfer element is then removed from the article, which has the image printed through its gloss protective coating, and which is therefore protected by the gloss coating from scratching and other degradation.

It will be appreciated by persons skilled in the art that the above embodiment has been described by way of example only, and not in any limitative sense, and that various alterations and modifications are possible without departure from the scope of the invention as defined by the appended claims.

1. A method of printing an image onto a 3-dimensional surface, the method comprising:
heating a transfer element having an image printed thereon to make the transfer element more flexible;
applying the heated transfer element to a 3-dimensional surface having a protective coating thereon, with substantially uniform pressure across the area of contact between the transfer element and the surface, such that the image faces the surface; and
heating the transfer element to at least partially transfer the image into the protective coating.

2. A method according to claim 1, further comprising the step of applying said protective coating.

3. A method according to claim 2, further comprising the step of applying a receptor coating prior to application of said protective coating.

4. A method according to claim 1, further comprising the step of printing an image onto said transfer element.

5. A method according to claim 4, wherein the image is printed by means of a digital printer.

6. A method according to claim 1, wherein the transfer element is applied to the surface by means of vacuum forming.

7. A method according to claim 1, wherein the transfer element is at least partially heated by means of hot gas.

8. A method according to claim 1, further comprising the step of applying a thermally conductive film to the transfer element.

9. A method according to claim 1, further comprising the step of removing solvent and/or moisture from a region adjacent said transfer element during heating thereof.

10. (canceled)

11. An apparatus for printing an image onto a 3-dimensional surface, the apparatus comprising:
at least one fixing device for fixing a transfer element, having an image printed thereon, in position relative to a 3-dimensional surface on which an image is to be printed and having a protective coating applied thereto;
at least one heating device for heating the transfer element to make it more flexible and to at least partially transfer the image into the protective coating; and
at least one application device for applying the flexible transfer element to the surface with substantially uniform pressure across the area of contact between the transfer element and the surface such that the image faces the surface.

12. An apparatus according to claim 10, wherein at least one said fixing device comprises at least one respective recess for receiving at least one part having a respective 3-dimensional surface, and for fixing a respective transfer element relative to the or each said part.

13. An apparatus according to claim 11, wherein the recess is at least partially removable from a housing of the apparatus, and the corresponding fixing device is adapted to fix the transfer element in response to insertion of the recess into the housing.

14. An apparatus according to claim 12, further comprising at least one further fixing device, for holding the or each said recess in position in the housing.

15. An apparatus according to claim 12, further comprising at least one control device for actuating at least one said heating device and/or at least one said application device in response to insertion of the recess into the housing.

16. An apparatus according to claim 10, wherein at least one said heating device is adapted to direct hot gas towards the surface.

17. An apparatus according to claim 10, further comprising at least one moisture and/or solvent removing device for removing solvent and/or moisture from a region adjacent the transfer element.

18. An apparatus according to claim 10, wherein at least one said application device comprises a respective vacuum forming device.

19. (canceled)

20. A transfer element adapted to have an image printed thereon, the transfer element comprising:
a carrier layer adapted to be heated to make the carrier layer more flexible;
an image supporting layer; and
a thermally conducting layer.

21. (canceled)
